(19) United States
(12) Patent Application Publication
(10) Pub. No.: US 2004/0006303 A1
(43) Pub. Date: Jan. 8, 2004

(54) Oral medicine delivery apparatus

(76) Inventor: Gary Takowsky, Beverly Hills, CA (US)

Correspondence Address: TOPE-MCKAY & ASSOCIATES, 23852 PACIFIC COAST HIGHWAY #311, MALIBU, CA, 90265, US

(21) Appl. No.: 10/192,435

(22) Filed: Jul. 8, 2002

(51) Int. Cl. A61J 7/00

(52) U.S. Cl. 604/78

(57) ABSTRACT

An apparatus comprises a medicine containing vessel for fitting in the bottom of a cup. The medicine containing vessel includes upper and lower halves. The upper half includes an opening for a straw. The upper and lower halves detachably attach so that they form a hollow medicine container to store liquid medicine to be dispensed through a straw for delivery to a patient. The method includes steps of adding medicine to a lower half of a medicine delivery vessel; attaching an upper half with the lower half to seal medicine therein; attaching a straw with a hole in the upper half; securing the medicine delivery vessel in the bottom of a cup; adding an attractive-looking liquid into the cup; and providing the cup to a child to drink through the straw, so that the child will drink the medicine while thinking they are drinking the attractive-looking liquid.

### BACKGROUND OF THE INVENTION

(1) Technical Field

The present invention relates to an oral medicine delivery apparatus for dispensing liquid ingredients such as medicines taken orally; and particularly, an oral medicine delivery apparatus for use with children.

(2) Discussion

Many pharmaceuticals and drugs for children are provided in the liquid form to facilitate oral administration. Often these medicines have a bitter or unpleasant taste and children refuse to take them. While spoons or medicine droppers may be carefully graduated to accommodate and dispense a precise dosage of a drug, a child may quickly learn a color, an overall look and smell of the particular medicine in an open spoon and refuse to take it. Often, dispensing medicine to an unwilling child results in frustration and a mess. In addition, spoons and medicine droppers may cause injury to the child. Spoons are usually made from solid, relatively heavy materials and can injure a resistive child. The medicine dropper, due to its pointed end, may also injure a child.

Mixing the medicine in a glass or a bottle with a liquid having a taste, which is pleasant and familiar to children, may provide an answer to dispensing certain kinds of medications to an unwilling child. However, for other types of drugs, it can present the problem of unwanted dilution of the medicine and can lead to inaccurate dosing.

A number of medical devices have been proposed in the prior art to overcome a child's reluctance to take medicine and other various apparatus have been suggested to overcome the unpleasant taste of medicines while delivering the correct dosage. For example, Botts (U.S. Pat. No. 6,270,519) teaches a nipple for use with liquid and a medicine dispensing bottle. The nipple is used with the liquid and medicine-dispensing bottle, which includes a medicine tube disposed therein, which allows medication and other liquids to be dispensed separately or simultaneously with the medicine. U.S. Pat. No. 5,244,122 suggests a medicine delivery apparatus resembling a traditional nursing bottle assembly having an internal open-ended receptacle to hold the medicine, with the nipple having an integral tube connecting the receptacle to a nipple outlet hole to dispense the medicine. Yin-Peng Liu et al. (U.S. Pat. No. 5,353,964) teaches a twin-bottle nursing bottle with one bottle positioned inside the other one and a diversion control switch allowing feeding two alternative fluids to a baby. Gomez-Acevedo (U.S. Pat. No. 5,269,425) teaches another form of dual chambered bottle, wherein an application of force is required to displace a plug separating different liquid compositions contained in the separate containers. U.S. Pat. No. 5,611,776 suggests an improved dual chambered baby bottle, which permits the sequential administration of different fluids to an infant, wherein access to the different compartments is accomplished by sucking action of the infant.

While the inventions described above are designed for dispensing liquids to babies and infants, they do not suggest the means to administer an unpleasant or bitter tasting medicine to older children. Therefore, a need exists for a safe device that allows administration of an undiluted medicine to a child in a manner that conceals the medicine so that a child believes they are drinking another fluid.

### SUMMARY OF THE INVENTION

An oral medicine delivery apparatus for delivering medicine to children is described herein. The apparatus comprises a medicine containing vessel for removably fitting into the bottom portion of a cup. The medicine containing vessel includes an upper half and a lower half, with the upper half including an opening for receiving a straw. The upper and lower halfes are formed for detachably attaching with each other so that when they are attached together they form a hollow medicine container to store liquid medicine to be dispensed through the opening and into a straw for delivery to a patient.

In a more preferred embodiment, a plurality of threads are included on the outer perimeter of the medicine containing vessel to allow the medicine containing vessel to be screwed into the bottom of a cup made of a soft material such as foam. Further, the upper half of the medicine containing vessel preferably comprises turning handles help facilitate the screwing and unscrewing of the medicine containing vessel into the bottom of a cup.

In yet another embodiment, the medicine delivery apparatus further includes a straw that is detachably attachable into the opening of the upper half of the medicine containing vessel to facilitate delivery of medicine to the child.

In a still further embodiment, the upper and lower halves of the medicine containing vessel are formed with threads for detachably attaching together. In addition, the straw and the opening in the upper half of the medicine containing vessel may be formed with threads for detachably attaching together.

The present invention may further include a cup into which the medicine containing vessel fits, with the cup including a bottom portion with inner perimeter, with the inner perimeter having threads to match with the threads on the perimeter of the medicine containing vessel. Thus, both the cup and the medicine delivery vessel may be designed to cooperate for the provision of medicine to a child. The cup may be designed to be clear, and the medicine containing vessel may be designed to disguise its contents from a child. The cup may further include a lid with a hole. The hole is preferably positioned to allow the straw to pass therethrough such that the position of the straw is constrained by the hole to minimize its motion relative to the medicine containing vessel.

In another embodiment, the medicine containing vessel has a perimeter, with the perimeter including a rubber layer to allow the medicine containing vessel to be detachably fitted into the bottom of a cup made of a hard material such as plastic or glass.

In a still further embodiment, the present invention comprises a method for delivering oral medicine to children. The method comprises steps of adding liquid medicine to a lower half of a medicine delivery vessel; attaching an upper half of the medicine delivery vessel with the lower half such that medicine is sealed therein; attaching a straw with a hole in the upper half of the medicine delivery vessel such that medicine may flow therethrough; securing the medicine delivery vessel in the bottom of a cup; adding an attractive-looking liquid into the cup; and providing the cup to a child to drink through the straw, whereby when the child drinks through the straw, they will drink the medicine while thinking they are drinking the attractive-looking liquid.

In another embodiment, the step of attaching the straw is performed by screwing the straw into the hole in the upper half of the medicine delivery vessel.

In yet another embodiment, the step of attaching a upper half of the medicine delivery vessel with the lower half such that medicine is sealed therein is performed by screwing the upper half to the lower half.

In one more embodiment, the step of securing the medicine delivery vessel in the bottom of a cup is performed by screwing the medicine delivery vessel into the bottom of the cup.

### BRIEF DESCRIPTION OF THE DRAWINGS

The novel features of the present invention are set forth in the appended claims. In order to better show the characteristics of the invention, some preferred embodiments are described hereafter, as examples without any limitative character. The features, aspects, and advantages of the present invention may be best understood in conjunction with the detailed description, with reference to the accompanying drawings where:

FIG. 1(a) is a perspective view of an oral medicine delivery apparatus according to the present invention and separated into a lower half and an upper half;

FIG. 1(b) is a perspective view of an oral medicine delivery apparatus according to the present invention depicting handles and a straw;

FIG. 2 is a perspective view of an oral medicine delivery apparatus according to the present invention including a straw and a cup with a lid; and

FIG. 3 is a flow chart depicting the steps in a method of the present invention.

### DETAILED DESCRIPTION

The present invention relates to the field medicine delivery, and more particularly to a medicine delivery apparatus and method for providing a medicine dose to a child. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

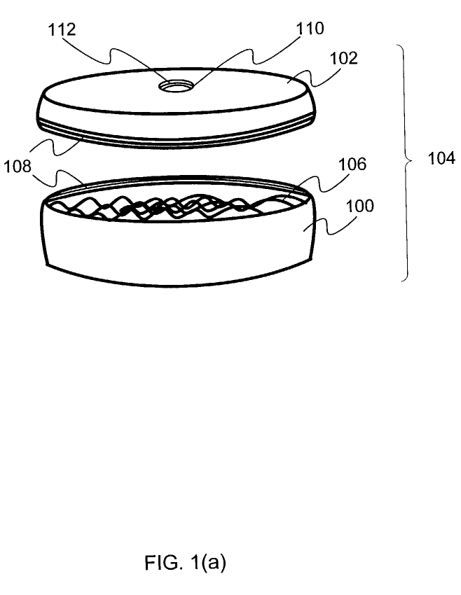

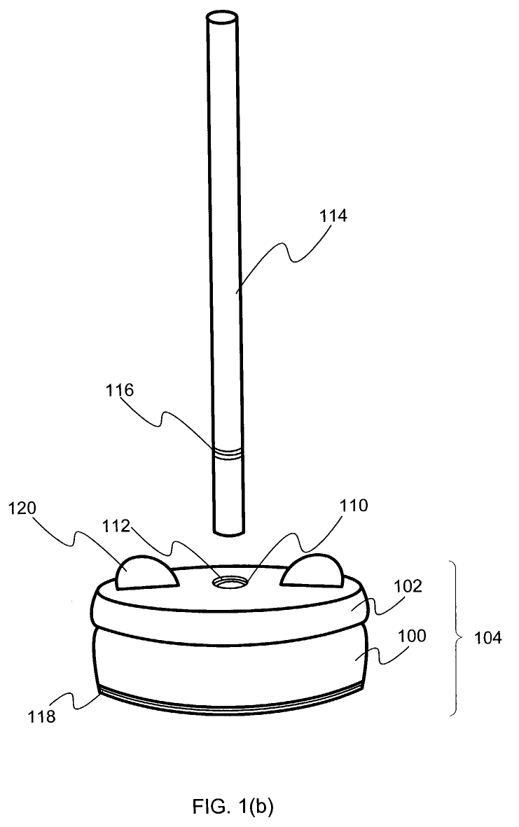

A perspective view of an oral medicine delivery apparatus according to the present invention is depicted in FIG. 1(a) with the lower half 100 and upper half 102 of the medicine containing vessel 104 separated. The lower half 100 and upper half 102 are formed such that when they are connected together they form a hollow chamber for holding a liquid medicine. In operation, a liquid medicine 106 is poured into the lower half 100 and then the lower half 100 and upper half 102 are joined to form a seal therebetween. A joining mechanism is provided for sealing the lower half 100 to the upper half 102. A non-limiting example of a joining mechanism includes sizing the lower half 100 and upper half 102 so that they may detachably attach with each other by friction. Various materials such as rubber may be used to provide a better seal. Another example is through the use of matching threads 108 in the lower half 100 and upper half 102, allowing the halves to be screwed together.

The upper half 100 further includes a hole 110 through which a straw may be passed to allow for the administration of the liquid medicine 106. The hole 110 preferably includes threads 112 into which the straw may be screwed in order to form a liquid-proof seal so that the liquid medicine 106 may pass through the straw without losing any medicine or mixing with another liquid.

A perspective view of an oral medicine delivery apparatus according to the present invention depicting handles and a straw is shown in FIG. 1(b). As shown, the lower half 100 and upper half 102 are connected to form a sealed medicine containing vessel 104. This embodiment includes a straw 114 having a threaded portion 116 that matches the threads 112 in the hole 110 of the upper half 102 of the medicine containing vessel 104. Note that other mechanisms, such as tight fitting rubber seals could be used instead of threads 112, 116 for attaching the straw to the medicine containing vessel 104. Also, threads 118 are more clearly shown formed about the perimeter of the medicine containing vessel 104. The threads 118 on the perimeter of the medicine containing vessel 104 are designed to it to be screwed into the bottom of a foam cup in order to secure the oral medicine delivery apparatus thereto. Other mechanisms such as rubber seals, etc. could also be used to frictionally fit the medicine containing vessel 104 to bottom of a foam cup. The embodiment depicted in FIG. 1(b) also includes handles 120 to assist in screwing (in a manner similar to that of a wingnut) or otherwise attaching the medicine containing vessel 104 to bottom of a foam cup.

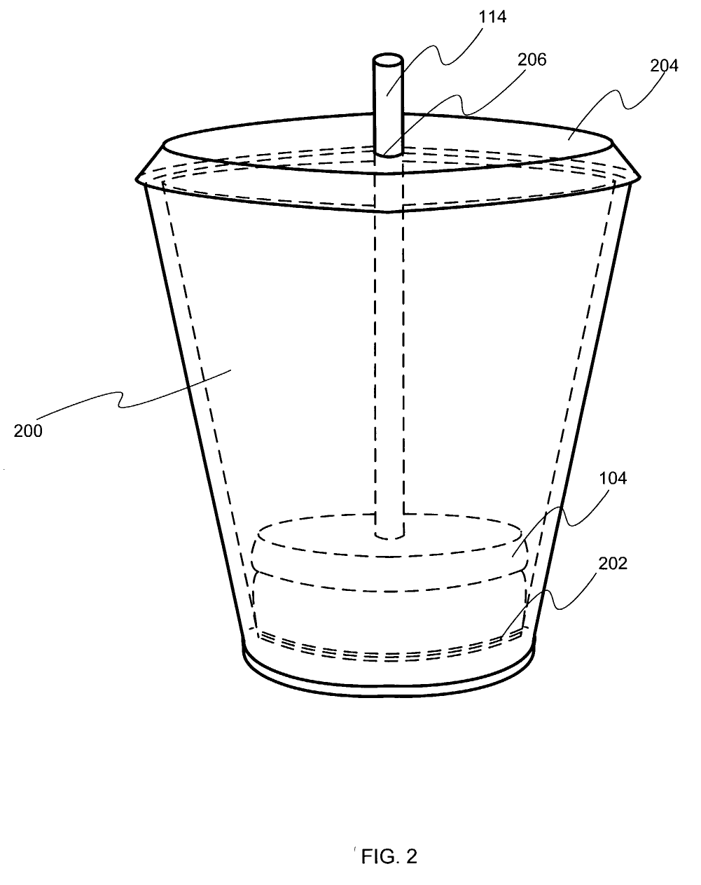

A perspective view of an oral medicine delivery apparatus according to the present invention including a straw and a cup with a lid is depicted in FIG. 2. In this embodiment, the cup 200 is depicted as a clear plastic cup, though it could be made of any desirable material such as foam or glass. As depicted, both the cup 200 and the medicine containing vessel 104 include matching threads 202 on its inner perimeter to ensure a proper fit therebetween. Additionally, a lid 204 is provided with a hole 206 for supporting the straw 114 so that its movement relative to the medicine containing vessel 104 is minimized. In operation, the cup 200 is filled with an attractive-looking liquid such as a juice or a punch in order to entice a child to drink from the straw. The lid 204 may be clear in order to permit the child to see the liquid. Note that in cases where the cup 200 is formed of a clear material, the medicine containing vessel 104 may be colored and shaped in a manner that minimizes the ability of a child to see it (e.g., it may be colored the same color as the liquid introduced into the cup 200).

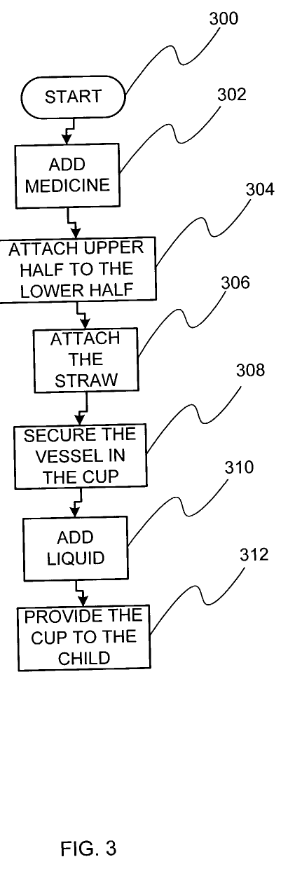

A flow chart depicting the steps in a method of the present invention is provided in FIG. 3. The method for delivering oral medicine to children begins at a starting block 300. After the start of the method, the person using the device performs a step of adding medicine to a lower half of a medicine delivery vessel 302. Subsequently, the user attaches the upper half of the medicine delivery vessel with the lower half such that medicine is sealed therein in an attaching step 304. This attachment may be performed by forcing the upper and lower half together so that a frictional fit is formed therebetween, or by means of threads which are used for screwing the two halves together. After the medicine delivery vessel is sealed, the user performs a step of attaching a straw with a hole in the upper half of the medicine delivery vessel such that medicine may flow therethrough and into a child's mouth when the device is used 306. As with the medicine delivery vessel, the straw may be connected with the hole so that a frictional fit is formed therebetween, or by means of threads which are used for screwing the straw into the hole. After the straw has been attached with the medicine delivery vessel, a step of securing the medicine delivery vessel in the bottom of a cup is performed 308 (e.g., threadably or frictionally). Next, a step of adding an attractive-looking liquid into the cup 310 is performed in preparation for delivering the medicine to a child. Finally, after the cup has been filled with the attractive looking liquid, a step of providing the cup to a child 312 is performed. When the child drinks through the straw, they will drink the medicine while thinking they are drinking the attractive-looking liquid.

What is claimed is:

1. An oral medicine delivery apparatus for delivering medicine to children, the apparatus comprising a medicine containing vessel for removably fitting in the bottom portion of a cup, the medicine containing vessel including an upper half and a lower half, with the upper half including an opening for receiving a straw, the upper half and lower half formed to detachably attach with each other so that when they are attached together they form a hollow medicine container to store liquid medicine to be dispensed through the opening and into a straw for delivery to a patient.

2. An oral medicine delivery apparatus for delivering medicine to children as set forth in claim 1, wherein the medicine containing vessel has a perimeter, with the perimeter including a plurality of threads to allow the medicine containing vessel to be screwed into the bottom of a cup made of a soft material such as foam.

3. An oral medicine delivery apparatus for delivering medicine to children as set forth in claim 2, wherein the upper half of the medicine containing vessel further comprises turning handles help facilitate the screwing and unscrewing of the medicine containing vessel into the bottom of a cup.

4. An oral medicine delivery apparatus for delivering medicine to children as set forth in claim 3, further comprising a straw that is detachably attachable into the opening of the upper half of the medicine containing vessel to facilitate delivery of medicine to the child.

5. An oral medicine delivery apparatus for delivering medicine to children as set forth in claim 4, where the upper and lower halves of the medicine containing vessel are formed with threads for detachably attaching together.

6. An oral medicine delivery apparatus for delivering medicine to children as set forth in claim 5, where the straw and the opening in the upper half of the medicine containing vessel are formed with threads for detachably attaching together.

7. An oral medicine delivery apparatus for delivering medicine to children as set forth in claim 6, further comprising a cup into which the medicine containing vessel fits, with the cup including a bottom portion having an inner perimeter, with the inner perimeter having threads to match with the threads on the perimeter of the medicine containing vessel.

8. An oral medicine delivery apparatus for delivering medicine to children as set forth in claim 7, wherein the cup is clear and the medicine containing vessel is designed to disguise its contents from a child.

9. An oral medicine delivery apparatus for delivering medicine to children as set forth in claim 8, wherein the cup includes a lid with a hole, with the hole positioned to allow the straw to pass therethrough such that the position of the straw is constrained by the hole to minimize its motion relative to the medicine containing vessel.

10. An oral medicine delivery apparatus for delivering medicine to children as set forth in claim 1, wherein the medicine containing vessel has a perimeter, with the perimeter including a rubber layer to allow the medicine containing vessel to be detachably fitted into the bottom of a cup made of a hard material such as plastic or glass.

11. An oral medicine delivery apparatus for delivering medicine to children as set forth in claim 10, wherein the upper half of the medicine containing vessel further comprises handles help facilitate the insertion and removal of the medicine containing vessel into the bottom of a cup.

12. An oral medicine delivery apparatus for delivering medicine to children as set forth in claim 1, further comprising a straw that is detachably attachable into the opening of the upper half of the medicine containing vessel to facilitate delivery of medicine to the child.

13. An oral medicine delivery apparatus for delivering medicine to children as set forth in claim 12, where the straw and the opening in the upper half of the medicine containing vessel are formed with threads for detachably attaching together.

14. An oral medicine delivery apparatus for delivering medicine to children as set forth in claim 1, where the upper and lower halves of the medicine containing vessel are formed with threads for detachably attaching together.

15. An oral medicine delivery apparatus for delivering medicine to children as set forth in claim 14, further comprising a cup into which the medicine containing vessel fits, with the cup including a bottom portion having an inner perimeter, with the inner perimeter having threads to match with the threads on the perimeter of the upper portion of the medicine containing vessel.

16. An oral medicine delivery apparatus for delivering medicine to children as set forth in claim 15, wherein the cup is clear and the medicine containing vessel is designed to disguise its contents from a child.

17. An oral medicine delivery apparatus for delivering medicine to children as set forth in claim 16, wherein the cup includes a lid with a hole, with the hole positioned to allow the straw to pass therethrough such that the position of the straw is constrained by the hole to minimize its motion relative to the medicine containing vessel.

18. A method for delivering oral medicine to children, the method comprising the steps of:
a. adding liquid medicine to a lower half of a medicine delivery vessel;
b. attaching an upper half of the medicine delivery vessel with the lower half such that medicine is sealed therein;
c. attaching a straw with a hole in the upper half of the medicine delivery vessel such that medicine may flow therethrough;
d. securing the medicine delivery vessel in the bottom of a cup;
e. adding an attractive-looking liquid into the cup; and
f. providing the cup to a child to drink through the straw, whereby when the child drinks through the straw, they will drink the medicine while thinking they are drinking the attractive-looking liquid.

19. A method for delivering oral medicine to children as set forth in claim 18, wherein the step of attaching the straw is performed by screwing the straw into the hole in the upper half of the medicine delivery vessel.

20. A method for delivering oral medicine to children as set forth in claim 18, wherein the step of attaching an upper half of the medicine delivery vessel with the lower half such that medicine is sealed therein is performed by screwing the upper half to the lower half.

21. A method for delivering oral medicine to children as set forth in claim 18, the step of securing the medicine delivery vessel in the bottom of a cup is performed by screwing the medicine delivery vessel into the bottom of the cup.
